(19) United States
(12) Patent Application Publication
(10) Pub. No.: US 2003/0040935 A1
(43) Pub. Date: Feb. 27, 2003

(54) Business information management system

(76) Inventor: Gerard Thomas Magee, Coogee (AU)

Correspondence Address: HOGAN & HARTSON LLP, ONE TABOR CENTER, SUITE 1500, 1200 SEVENTEENTH ST, DENVER, CO, 80202, US

(21) Appl. No.: 10/204,690

(22) PCT Filed: Jul. 3, 2001
(86) PCT No.: PCT/AU01/00794

(30) Foreign Application Priority Data
Jul. 3, 2000 (AU) PQ 8539

(51) Int. Cl. G06F 17/60

(52) U.S. Cl. 705/1; 705/30; 705/26

(57) ABSTRACT

A business information management system for facilitating transactions between a business entity and a second entity, comprising a database (8) containing organisation data for the business entity, the organization data defining a hierarchical arrangement (12) of users (24,26,28,30,32,34) within the business entity; Interface means (6) to a communications system for exchanging data with the second entity (4); an engine (10) in communication with the interface (6) and arranged to exchange data with the second entity (4) regarding a transaction between the business entity and the second entity (4), and to store said data in the database (8), the engine (10) having a plurality of operations that can be performed on the data; The database (8) further containing configuration data defining business rules to control said operations, each user's access to data in the database and which of said operations each user may perform on said data.

### FIELD OF THE INVENTION

This invention relates to a business information management system for facilitating transactions between a business entity and a second entity.

### BACKGROUND ART

Business information management systems have focussed on one aspect of a business to the exclusion of other aspects. As a result, existing businesses have required several information management systems, each performing a separate function. Examples of these information management systems include stock management, accounting packages, production management, and procurement packages. With the advent of electronic commerce, additional information management systems regarding electronic commerce have become commonplace, such as an on-line catalog, and an on-line shopping cart facility.

At present, businesses are not levering the maximum benefit from these systems, primarily due to difficulties in interfacing the separate systems together. In addition, in many instances information is simply not captured by the existing information systems and so it cannot be utilised by the business. For example, information on an invoice as to what products were purchased by or services provided to the business are not captured in many accounting packages. Thus, the business is not readily able to analyse this information, or to integrate it into their stock management information system.

The existing situation results in multiple data entries for the same information, and requires significant expenditure on the part of the business to purchase and maintain all of the information management systems.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of this invention, there is provided a business information management system for facilitating transactions between a business entity and a second entity, comprising:

A database containing organisation data for the business entity, the organization data defining a hierarchical arrangement of users within the business entity;

Interface means to a communications system for exchanging data with the second entity;

An engine in communication with the interface and arranged to exchange data with the second entity regarding a transaction between the business entity and the second entity, and to store said data in the database, the engine having a plurality of operations that can be performed on the data;

The database further containing configuration data defining business rules to control said operations, each user's access to data in the database and which of said operations each user may perform on said data.

Preferably, the operations comprise commercial operations, production operations, and analysis operations.

Preferably, the commercial operations include at least one of: transmitting or receiving request data for products and/or services and/or projects; transmitting or receiving offer data regarding request data; transmitting or receiving order data regarding offer data; transmitting or receiving dispatch data regarding products and/or services and/or projects in relation to order data; transmitting or receiving delivery data regarding products and/or services and/or projects in relation to order data; transmitting or receiving invoice data regarding order data; and transmitting or receiving payment data regarding invoice data.

Preferably, the production operations include at least one of: generating a producation schedule form regarding said request data, offer data or order data; generating a stock requirement form regarding said request data, offer data or order data; generating a dispatch requirement form regarding said request data, offer data or order data; generating a delivery requirement form regarding said request data, offer data or order data.

Preferably, the analysis operations include at least one of: generating a trends form in relation to said request data, offer data, order data, dispatch data, delivery data, or invoice data.

Preferably, said forms include means for receiving form data entered from a user in said business entity, said engine being arranged to receive said form data, store it in the database and perform operations on said form data in accordance with said configuration data.

Preferably, said configuration data further comprises trigger data, said engine being responsive to the trigger data and to the data to determine whether to perform an operation.

Preferably, the database further contains inventory data defining a plurality of products and/or services and/or projects, said whereby said configuration data defines for each user whether that user can perform an operation to transmit or receive a request, offer, order dispatch, delivery or invoice in relation to said inventory data.

Preferably, at least one of said product and/or service and/or project in said inventory data is associated with a predetermined second entity, and whereby said engine is arranged to perform said transmit or receive operations to said predetermined second entity in relation to said product and/or service and/or project.

Preferably, if a user-initiated operation exceeds a user's access, said operation is forwarded to another user above said user in said organisation data.

Preferably, the database further contains second entity data defining which second entities said engine will exchange information with.

Preferably, said request data includes:

a category data field representing the type of product or service the request data relates to;

a buyer entity identifier;

at least one description data field for storing data describing the good/service the request data relates to selected from: a desired manufacturer data field, a desired item model data field, a desired delivery date and time data field, a general description data field;

an offer closing date and time data field; and

a maximum price data field.

Preferably, the database further contains category data representing categories of goods and/or services and/or projects the business entity is interested in.

Preferably, the engine is arranged to filter said request data according to the category data.

Preferably, said offer data includes price data, an earliest delivery date and time, a request data identifier, an offer bonus description data field, a description data field, and a business entity data identifier.

### BRIEF DESCRIPTION OF THE DRAWING(S)

The invention will now be described with reference to one embodiment thereof and the accompanying drawing, in which:

FIG. 1 is a block diagram of a business information management system according to the embodiment of the invention.

### BEST MODE(S) FOR CARRYING OUT THE INVENTION

The embodiment is directed towards a business information management system 2 for facilitating transactions between a business entity and a second entity 4.

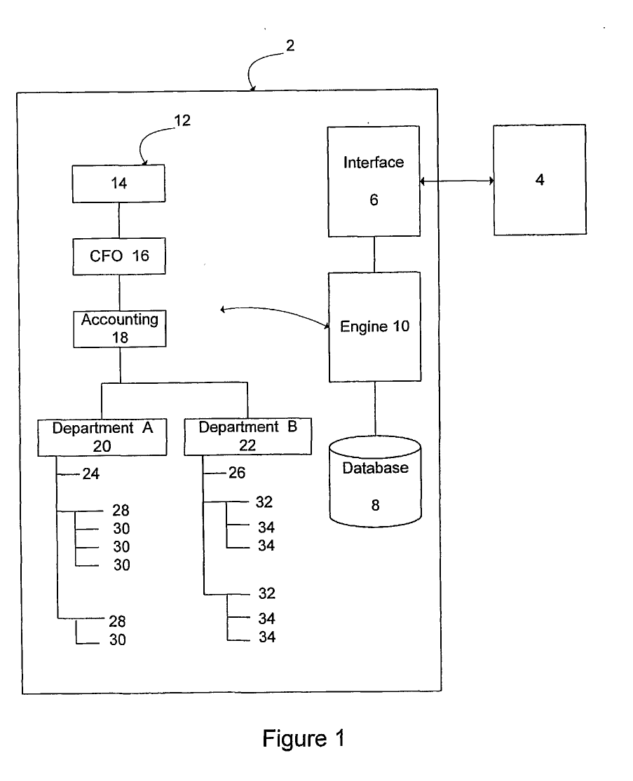

FIG. 1 shows the system 2 and the second entity 4. The system 2 comprises a communications interface 6, a database 8 and an engine 10. In the embodiment, the communication interface 6 comprises a world wide web interface for the Internet, such as Oracle webforms. It should be appreciated that in other embodiments, alternative or additional interfaces and protocols for use therewith, or interfaces and protocols for other communication mediums may be adopted as appropriate, such as WAP and 3-G protocols and interfaces.

The engine 10 is in communication with the interface 6 and is arranged to exchange data with the second entity 4 regarding a transaction between the business entity and the second entity 4. The engine 10 is arranged to store said data in the database 8. The engine 10 further comprises a plurality of operations that can be performed on the data.

The database 8 contains organisation data, and configuration data defining business rules to control said operations of the engine 10, user access to data in the database 8 and which of said operations each user may perform on said data, as described in more detail below.

The system 2 of the embodiment allows for access by multiple users within the business entity. In order to manage the multi-user access, the database 8 includes organisation data defining an organisation hierarchy 12.

The hierarchy 12 comprises the general organisation at 14 at the top of the hierarchy, and beneath the general organistion 14 an executive officer such as the chief financial officer at 16 who presides over an accounting division 18. The chief financial officer (CFO) 16 has the primary responsibility for administering the restrictions that may be placed on other users of the system and the business rules as described in more detail below.

The accounting division 18 is responsible for handling payment of invoices, and the necessary cross referencing of receipts and statements to invoices.

The hierarchy 12 also includes a first department 20 and a second department 22, each of which are defined beneath the accounting division 18. The departments 20 and 22 have equal priority within the hierarchy 12. The term department is used in the embodiment as a general reference to any useful division within the business entity. Thus, departments may represent teams such as a sales team, departments such as manufacturing, shipping, sites such as warehouse and commercial or any combination of these. The departments are a logical construct to simplify the allocation of business rules by the CFO 16. Accordingly, any suitable division within the business entity may be represented by the departments 20, 22. Further, it should be appreciated that in other embodiments, more that two departments may be defined.

Each department 20 and 22 has a head user 24 and 26, respectively. Beneath the head user 24 there are several users 28, and beneath users 28 are sub-users 30. Similarly, beneath the head user 26 there are several users 32, and beneath users 32 are sub-users 34.

The engine 10 has operations that it performs on data in the database 8 in accordance with the business rules. Rather that being restricted to a single system such as accounts, the operations and business rules are configurable according to the requirements of the business entity. In the embodiment, the operations consist of commercial operations, production operations and analysis operations. Commercial operations control how the engine 10 manipulates and controls data in the database 8 concerning requests for cost estimates, offers to supply, orders, dispatch, delivery and invoices. Production operations control how the engine 10 manipulates and controls data in the database 8 in relation to the scheduling and production or supply of products, services or projects arising from the commercial operations. The analysis operations control how the engine 10 manipulates and controls data in the database 8 to provide the business entity with business trand information regarding commercial or production operations.

In the embodiment, the commercial operations comprise:

transmitting to or receiving from the second entity request data for products and/or services and/or projects;

transmitting to or receiving from the second entity offer data regarding request data;

transmitting to or receiving from the second entity order data regarding offer data;

transmitting to or receiving from the second entity dispatch data regarding products and/or services and/or projects in relation to order data;

transmitting to or receiving from the second entity delivery data regarding products and/or services and/or projects in relation to order data;

transmitting to or receiving from the second entity invoice data regarding order data; and

transmitting to or receiving from the second entity payment data regarding invoice data.

Further, the production operations comprise:

generating a producation schedule form regarding said request data, offer data or order data;

generating a stock requirement form regarding said request data, offer data or order data;

generating a dispatch requirement form regarding said request data, offer data or order data;

generating a delivery requirement form regarding said request data, offer data or order data.

Further, in the embodiment, the analysis operations comprise generating a trends form in relation to said request data, offer data, order data, dispatch data, delivery data, or invoice data.

Using the commercial operations, the engine 10 is configured to act as a procurement system in relation to request, offers, orders, dispatch, delivery and invoices. The engine 10 also stores information in the database 8 on transactions, enabling the system 2 to also act as an inventory system and accounting system.

The business rules in the configuration data determine the operation of the engine 10. For example the business rules can be used to allocate permissions to users within the business entity, for example whether a particular user is able to order items for the business entity, which operations the user is able to use and so on. The business rules have a wider application, however, and can also be used to indicate rules for each department 20, 22, rules for all departments, rules for particular products and/or goods and/or projects.

For example, the business rules can be configured so that the head users 24, 26 have responsibility for authorising all the requests for purchases from within their department. Further, the business rules can provide a maximum value of products and/or goods and/or projects that the head users 24, 26 can authorise, above which the request is sent to the accounting division 18 or the CFO 16 for approval. In addition, business rules can be used to allocate budgets to users and/or head users for expenditure over a period, whereby requests for products and/or goods and/or projects in excess of the budget are automatically sent to the accounting division 18 or the CFO for approval. The foregoing examples are a single illustration of the application of business rules to provide permissions to users in the business entity. As seen, the business rules allow the CFO 16 to configure the engine 10 to operate in an analogous manner to any existing systems within the business entity.

In addition, each department head 24, 26 and each user 28, 32 is able to view the history of previous purchases made by any person that is lower in the hierarchy than themself. Thus, the department heads 24, 26 are able to view a history of all purchases made by all users defined as being within that department, and each user 28, 32 is able to view history of purchases made by them and each of the sub-users 30, 34 defined beneath them.

The hierarchy 12 provides a simple yet effective mechanism for the CFO 16 to be able to maintain a degree of control over the expenditure within each department 20 and 22 while still allowing each department and users within that department a degree of autonomy in purchasing routine items. Importantly, purchases of day to day items will still be captured and recorded in each departments budget.

In addition, users are able to view all current requests, orders, offers, invoices, dispatches and deliveries to which they have permission. Users can sort the data by products and/or goods and/or projects or supplier. The accounting division 18 and the CFO 16 can view all invoices and can schedule invoices for payment on particular dates.

It should be appreciated that in practice a business entity is likely to both be a purchaser and a supplier of a range of products and/or goods and/or projects, and accordingly some or all of the users may have permissions in relation to both purchasing and supplying goods.

In one configuration, the database 8 of the business entity includes inventory data that describes pre-defined items that users within the organisation hierarchy a may order. In this configuration of business rules, users within the organisation hierarchy 12 are not permitted to freely browse catalogues from suppliers, but are restricted to requesting items contained in the pre-defined list stored in the inventory data. Each item in the pre-defined list may be associated with a specific second entity 4, so that when that item is requested, an order is directly placed with the second entity 4. Alternatively, the item may be sent to all allowable suppliers as a request for a price. Further, additional business rules may define that all orders for particular goods and/or services and/or projects are not transmitted to the second entity, but are sent to the accounting division 18. This allows the accounting division 18 to bundle multiple orders for the same item into a single, larger order.

In an alternative configuration, the database 8 may not contain any inventory data, and instead users within the organisation hierarchy 12 may be permitted to make general product requests, and browse catalogues of suppliers.

In a third configuration, these configurations may be combined, such that certain users may have access permissions that enable them only to request items from the pre-defined list in the inventory data stored in the database 8, whilst other users have permissions that enable them to request items in the inventory data, or to request items of a general nature from a supplier.

Further, the database 8 can include supplier data defining which suppliers the engine 10 will transmit data to via the interface 6. The supplier data may be configured as all suppliers, or all suppliers excluding specific suppliers, or only specific suppliers, as chosen by the CFO 16. Further, additional business rules may define particular suppliers for certain products ands/or services and/or projects.

The following example indicates one arrangement of the business rules for user as a transaction system for a purchaser.

### EXAMPLE 1

In use, any user permitted by the business rules within the organisation hierarchy 12 may initiate a request for prices on one or more products ands/or services and/or projects. If for example a sub-user 30 initiated a request for six items, the sub-user 30 completes a description of the quantity of each item required along with as much information concerning the make, model and specification of each item as the user wishes to provide. The sub-user 30 may also specify a date and time when responses to the request is required, and a date, time and method of delivery of the items in the request.

If the value of the items exceeds the sub-user 30 maximum allowance, the request is submitted to the user 28 from which the sub-user 30 depends in the organisation hierarchy 12. The user 28 may either approve or deny the request. If the request is approved but the value of the items exceed the user's 28 maximum allowance, the request would be submitted the department head 24 who again may approve or deny the request.

An approved request is stored in the database 8 and is communicated by the engine 10 to second entities in the form of suppliers according to the allowable supplier data in the database 8.

Where the supplier is also using the system 2, users within the supplier may view those items within the request that correspond with their category of products for which they can provide prices. Users within the supplier are able to receive information in requests from multiple purchasers, and may sort those requests according to desired criteria including the purchaser, item category, model, manufacturer, quantity, and date and times. This provides the supplier with a significant degree of flexibility.

A user within the supplier may respond to one or more items in the request by providing a price to supply the items, availability and delivery date. Where the request is for a specific manufacturer and model of item, the price from the supplier is to supply that particular item. Where the request is for a general category of item, such as a facsimile machine, the supplier will provide additional information concerning the manufacturer and model of the item that the supplier is proposing to provide in response to the requested item.

In a similar manner to that described above in relation to users within the business entity submitting requests, users within the supplier have a similar hierarchical permission system for responding to a request. For instance, if a sub-user were to respond to the request, and the value of the items in response to the request exceeded the sub-user threshold allowance, the response to the request would be forwarded to the user responsible for the sub-user in the supplier for approval.

This process would continue until the response to the request was either approved or denied.

If the response to the request is approved, information concerning the response are stored in the supplier's database as an offer, and this offer is communicated to the system 2 of the business entity.

The offer is stored by the engine in the database 8 and is linked to the request. The user within the organisation hierarchy 12 that initiated the request to which the offer relates may view all of the offers in relation to the request. The offers are also accessible by any user in the organisation hierarchy above the user who initiated the request.

When an offer is received that is desirable, the offer is accepted by a user 28 or sub-user 30. Once an offer is accepted, a copy of the offer is stored in the database 8 as a quotation, and an order for completing that quotation is transmitted to the relevant supplier. A copy of the order is also stored in the database 8 by the engine 10.

The order is received and stored in the supplier database awaiting fulfilment. Upon dispatch from the supplier, the database of the supplier is updated to indicate that the products and/or services and/or projects have been sent to the business entity.

Once the order has been marked by as being fulfilled, an invoice is generated by the supplier and transmitted to the business entity. The invoice is stored in the database of the supplier, and upon receipt by the business entity is also stored in the database 8 and is linked to the order and the quotation.

Upon delivery, the order is marked as received by a user within the business entity, whereupon the business rules forward the invoice to the accounts division 18 for approval.

Once the invoice 46 has been approved by the accounting division 18 or the CFO 16, payment for the invoice is effected using known electronic payment mechanisms and the payment is transmitted to the supplier. Details of the payment are stored in the database 8 and are linked to the invoice.

Details of the payment are received by the supplier and stored in its database and linked to the invoice. Subsequently, a receipt and statement are generated by the supplier and transmitted to the business entity which are also stored in the database 8.

At any time, a user can gather information from the database 8 concerning current, outstanding and satisfied requests, offers, orders, dispatches, deliveries and invoices according to their permissions.

More advantageously, users with appropriate permissions are able to execute production and analysis operations. Thus, the business entity can use the system to not only use purchase items and receive orders, but can generate work schedules based on existing orders and their delivery dates. This provides an integrated package for a business entity not prevously available. Further, as orders are fulfilled, business rules may be provided for automatically generating an order to replensish stock used in producing the order for approval by a user.

Further, the analysis operations allow users with appropriate permissions to obtain useful data regarding many aspects of the system 2.

Where required, the database 8 is able to export information to a separate accounting package.

1. A business information management system for facilitating transactions between a business entity and a second entity, comprising:
A database containing organisation data for the business entity, the organization data defining a hierarchical arrangement of users within the business entity;
Interface means to a communications system for exchanging data with the second entity;
An engine in communication with the interface and arranged to exchange data with the second entity regarding a transaction between the business entity and the second entity, and to store said data in the database, the engine having a plurality of operations that can be performed on the data;
The database further containing configuration data defining business rules to control said operations, each user's access to data in the database and which of said operations each user may perform on said data.

2. The system of claim 1, wherein the operations comprise commercial operations, production operations, and analysis operations.

3. The system of claim 2, wherein the commercial operations include at least one of: transmitting or receiving request data for products and/or services and/or projects; transmitting or receiving offer data regarding request data; transmitting or receiving order data regarding offer data; transmitting or receiving dispatch data regarding products and/or services and/or projects in relation to order data; transmitting or receiving delivery data regarding products and/or services and/or projects in relation to order data; transmitting or receiving invoice data regarding order data; and transmitting or receiving payment data regarding invoice data.

4. The system of claim 3, wherein the production operations include at least one of: generating a producation schedule form regarding said request data, offer data or order data; generating a stock requirement form regarding said request data, offer data or order data; generating a dispatch requirement form regarding said request data, offer data or order data; generating a delivery requirement form regarding said request data, offer data or order data.

5. The system of claim 3 or 4, wherein the analysis operations include at least one of: generating a trends form in relation to said request data, offer data, order data, dispatch data, delivery data, or invoice data.

6. The system of claim 4 or 5, wherein said forms include means for receiving form data entered from a user in said business entity, said engine being arranged to receive said form data, store it in the database and perform operations on said form data in accordance with said configuration data.

7. The system of any one of claims 1 to 6, wherein said configuration data further comprises trigger data, said engine being responsive to the trigger data and to the data to determine whether to perform an operation.

8. The system of any one of claims 1 to 7, wherein the database further contains inventory data defining a plurality of products and/or services and/or projects, said whereby said configuration data defines for each user whether that user can perform an operation to transmit or receive a request, offer, order dispatch, delivery or invoice in relation to said inventory data.

9. The system of claim 8, wherein at least one of said product and/or service and/or project in said inventory data is associated with a predetermined second entity, and whereby said engine is arranged to perform said transmit or receive operations to said predetermined second entity in relation to said product and/or service and/or project.

10. The system of any one of claims 1 to 9, wherein if a user-initiated operation exceeds a user's access, said operation is forwarded to another user above said user in said organisation data.

11. The system of any one of claims 1 to 10, wherein the database further contains second entity data defining which second entities said engine will exchange information with.

12. The system of any one of claims 3 to 6, wherein said request data includes:
a category data field representing the type of product or service the request data relates to;
a buyer entity identifier;
at least one description data field for storing data describing the good/service the request data relates to selected from: a desired manufacturer data field, a desired item model data field, a desired delivery date and time data field, a general description data field;
an offer closing date and time data field; and
a maximum price data field.

13. The system of claim 12, wherein the database further contains category data representing categories of goods and/or services and/or projects the business entity is interested in.

14. The system of claim 13, wherein the engine is arranged to filter said request data according to the category data.

15. The system of any one of claims 1 to 14, wherein said offer data includes price data, an earliest delivery date and time, a request data identifier, an offer bonus description data field, a description data field, and a business entity data identifier.
